(19) United States
(12) Patent Application Publication
(10) Pub. No.: US 2024/0185613 A1
(43) Pub. Date: Jun. 6, 2024

(54) OBJECT DETECTION SYSTEM

(71) Applicant: Zimeno Inc., Livermore, CA (US)

(72) Inventors: Sanket GOYAL, Pleasanton, CA (US); Bijju K. VEDURUPARTHI, Habsiguda (IN); Ihsane DEBBACHE, Singapore (SG)

(73) Assignee: Zimeno Inc., Livermore, CA (US)

(21) Appl. No.: 18/523,789

(22) Filed: Nov. 29, 2023

Related U.S. Application Data
(60) Provisional application No. 63/429,185, filed on Dec. 1, 2022.

(51) Int. Cl. G06V 20/58; G06T 7/11; G06T 7/277; G06T 7/73; G06V 10/80; G06V 20/70

(52) U.S. Cl. CPC G06V 20/58; G06T 7/11; G06T 7/277; G06T 7/74; G06V 10/803; G06V 20/70; B62D 6/00; G06T 2207/10012; G06T 2207/10028; G06T 2207/20084; G06T 2207/30261; G06V 2201/08

(57) ABSTRACT

An object detection system may apply an object detection model to the first image frame to predict a location of a first bounding box of an object in the first image frame and apply a confidence value to the predicted location of first bounding box. In response to the confidence level exceeding a predetermined threshold, a location of a second bounding box in the second image frame may be estimated based on the location of the first bounding box and non-zero movement of the vehicle. The object detection model is updated based on the estimated location of the second bounding box in the second image frame. A location of a third bounding box in the third image frame is predicted using the updated object detection model. An operation of the vehicle is controlled based on the predicted location of the third bounding box.

### CROSS-REFERENCE TO RELATED PATENT APPLICATIONS

The present non-provisional application claims benefit from co-pending U.S. provisional patent Application Ser. No. 63429185 filed on Dec. 1, 2022, by Sanket Goyal and entitled OBJECT DETECTION SYSTEM, the full disclosure of which is hereby incorporated by reference.

### BACKGROUND

Supervised machine learning models are trained on a corpus of datasets to maximize performance at a task before deployment to production. The datasets are collected, cleaned, labelled, and then fed to the models for training, validation, and testing. Often, the distribution of the data collected cannot represent the dynamic inputs the model may face when deployed. This is due to the data drift caused by changing world, weather, climate, place, etc. . . . On the other hand, the concept of association among objects in the real world is also prone to change due to changes in user preferences, surroundings, and unexpected environmental and use case changes. This inherently causes what is known as concept drift. Data and concept drift are detrimental to the model performance because the model encounters unseen data on which it was never trained. Therefore, there is a need to update models once they are deployed to production.

### BRIEF DESCRIPTION OF THE DRAWINGS

FIG. 1 is a diagram schematically illustrating portions of an example object detection system.

FIG. 2 is a flow diagram of an example object detection method.

FIG. 3 is a diagram schematically illustrating portions of an example image segmentation system.

FIG. 4 is a flow diagram of an example method for updating an image segmentation model.

FIG. 5 is a perspective view illustrating portions of an example object detection system.

FIG. 6 is a bottom view illustrating portions of the example object detection system of FIG. 5.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are neural networks that serve as machine learning models. The neural networks are fed with image data comprising of an array of pixel values over one or more time-instances. Fine tuning a neural network includes adapting their weights or model parameters to better perform at a task. Disclosed are example image segmentation systems that may include a vehicle, a camera carried by the vehicle to output an image, a sensor to output a point cloud corresponding to the image and a processor. The system may further include a non-transitory computer-readable medium. The medium may direct the processor to apply a segmentation model to the image to output a first predicted segmentation map including pixel labels, fuse the first predicted segmentation map and the point cloud and label pixels in the point cloud. The medium may further direct the processor to relabel the pixel labels of the predicted segmentation map based on the labeled pixels in the point cloud to produce a second predicted segmentation map, compute a first quantity objectness score for an object in the first predicted segmentation map, compute a second quantity objectness score for an object in the depth refined segmentation map and use the depth refined segmentation map to adjust the segmentation model. The processor may adjust the segmentation model with additional constraints in the loss function to output a prediction that mimics the depth refined segmentation map. A second image may be segmented by the processor using the updated segmentation map, wherein the processor may control an operation of the vehicle based on the segmenting of the second image.

In some implementations, the estimating of the location of the second bounding box in the second image comprises applying a Kalman filter and correlating the estimated location of the second bounding box within a margin around the location of the first bounding box. In some implementations, the updating of the object detection model is based on a plurality of estimated locations of bounding boxes in a plurality of respective image frames. Disclosed are example non-transitory computer-readable mediums that may contain instructions to direct the processor to apply an object detection model to a first image frame to predict a location of a first bounding box of an object in the first image frame; and apply a confidence value to the predicted location of first bounding box. In response to the confidence level exceeding a predetermined threshold, the instructions may direct the processor to estimate a location of a second bounding box of the object in a second image frame based on the location of the first bounding box and non-zero movement of the vehicle and update the object detection model based on the estimated location of the second bounding box in the second image frame. The processor may further predict a location of a third bounding box of the object in a third image frame using the updated object detection model and control an operation of the vehicle based on the predicted location of the third bounding box.

In some implementations the sensor comprises a second camera, wherein the camera and the second camera form a stereo camera. In some implementations, the sensor comprises a LIDAR sensor.

For purposes of this disclosure, a network trained processor refers to one or more processors that utilize artificial intelligence in that they utilize a network or model that is been trained based upon various source or sample data sets. One example of such a network or model is a fully convolution on neural network. Another example of such a network is a convolutional neural network or other networks having a U-net architecture. Such networks may comprise vision transformers.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this, unless explicitly recited to the contrary, recitations reciting that signals “indicate” a value or state means that such signals either directly indicate a value, measurement or state, or indirectly indicate a value, measurement or state. Signals that indirectly indicate a value, measure or state may serve as an input to an algorithm or calculation applied by a processing unit to output the value, measurement or state. In some circumstances, signals may indirectly indicate a value, measurement or state, wherein such signals, when serving as input along with other signals to an algorithm or calculation applied by the processing unit may result in the output or determination by the processing unit of the value, measurement or state.

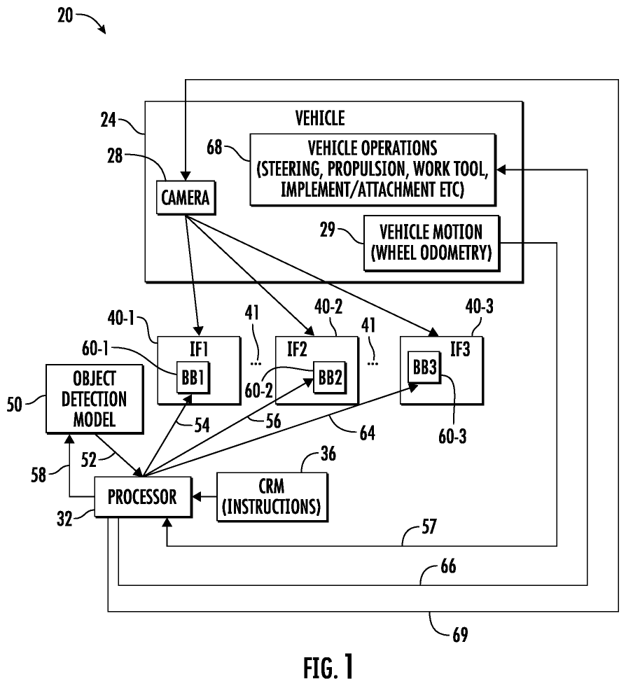

FIG. 1 is a diagram schematically illustrating an example object detection system 20. Object detection system 20 is configured to detect stationary or moving objects or obstacles near a vehicle, such as an automobile or tractor, when the vehicle is stationary or during movement of the vehicle. Vehicles operations, to the steering the vehicle, propulsion of the vehicle, actuation of a work tool (such as a bucket, fork, drill) or actuation of an implement or attachment (being pushed or pulled by the vehicle may be adjusted based upon the detected presence and location are position of the object or obstacle. Detection system 20 facilitates automatic fine-tuning or updating of a machine learning model (in the form of an object detection model) as a stream of images are being captured by a camera carried by the vehicle. System 20 comprises vehicle 24, camera 28, processor 32, and computer readable medium 36.

Vehicle 24 comprise a vehicle configured to traverse a terrain. In some implementations, vehicle 24 is a human driven vehicle having a human operator carried by the vehicle. In some implementations, vehicle 24 is a remotely driven vehicle having a human operator remotely controlling the vehicle from a location remote from the vehicle. Some implementations, vehicle 24 comprise an autonomous vehicle controlled and driven in an automatic fashion by a computerized controller. In some implementations, vehicle 24 may comprise an automobile or truck. In some implementations, vehicle 24 may comprise a tractor, a piece of construction equipment or the like.

Camera 28 comprise a device carried by vehicle 24 that is configured to capture and output a stream of image frames including a first image frame 40-1, a second image frame 40-2, and a third image frame 40-3 (collectively referred to as image frames 40). As schematically indicated by the ellipses 41, image frames 40 may be consecutive image frames in the stream or may be spaced intervening image frames. Image frames 40 are transmitted to and received by processor 32.

Processor 32 comprises a processing unit configured to carry out various computing operations based upon instructions contained on computer readable medium 36. Computer readable medium 36 comprises a non-transitory computer-readable medium in the form of software. In some implementations, processor 32 and computer readable medium 36 may be embodied as an application-specific integrated circuit. The instructions contained in computer readable medium 36 direct processor 32 to carry out a process for identifying the location of potential obstacles or objects in or near the path of vehicle 24.

The instructions contained in computer readable medium 36 direct processor 32 to apply an object detection model 50 to the received image frames 40 as part of predicting or estimating a bounding box (BB). The bounding box represents in the image containing an obstacle or object. In some implementations, the bounding box may represent the outline or boundaries of the location to be avoided by the vehicle as it traverses a field or other terrain. In some implementations, the bounding box may represent a portion of the image frame that is to be set apart and segmented to determine the shape and perimeter coordinates of the object or obstacle contained within the boundary box.

As schematically indicated by arrows 52 and 54, processor following instructions in CRM 36, applies object detection module 50 to image frame 40-1 to predict a location of the first bounding box BB1 60-1 of an object/obstacle. Processor 32 further applies a confidence value or measurement to the predicted location of bounding box 60-1.

Processor 32, following instructions contained in CRM 36 compares the confidence value to a predetermined threshold. As indicated by arrow 56, in response to the confidence value or level exceeding a predetermined threshold, processor 32 estimates a location of a second bounding box BB2 60-2 in the second image frame 40-2 based on the previously predicted location of the bounding box 60-1 in image frame 40-1 and non-zero movement of vehicle 24. As indicated by arrow 57, the movement of vehicle 24 may be obtained by processor 32 from other sensors on vehicle 24 which output signals indicating movement of vehicle 24. For example, processor 32 may receive wheel odometry data 29 from vehicle 24 indicating direction and vehicle speed of vehicle 24 that may have occurred between the capturing of image frame 40-1 and image frame 40-2. The estimation of the location of the bounding box may occur in response to an inability of the object detection model 50 to directly predict the location of the bounding box 60-2 in image frame 40-2.

In some implementations, processor 32, following instructions contained in CRM 36, may apply a Kalman filter when estimating the location of the second bounding box 40-2. Processor 32 may further correlate the estimated location of the second bounding box 60-2 within a margin about the previously predicted location of the bounding box 60-1.

As indicated by arrow 58, the estimated location of bounding box 60-2 may be then used as a basis for updating the object detection model 50. In some implementations, processor 32 may update the object detection model based on a plurality of estimated locations of bounding boxes 60 in a plurality of respective image frames 40. In some implementations, processor 32 may update model 50 after each image frame 40. In some implementations, processor 32 may update model 50 after bounding boxes have been estimated or predicted in a predefined minimum number of image frames.

As indicated by arrow 64, processor 32 may predict the location of a third bounding box BB3 60-3 (containing the same object or obstacle as contained in bounding box 60-1 and 60-2) in the third image frame 40-3 using the updated object detection model 50.

As indicated by arrow 66, processor 32, following instructions contained in CRM 36, may output control signals, controlling vehicle operation 68 of vehicle 24 based upon the particular location of the third bounding box 60-3. Such vehicle operation 68 may include an adjustment to the steering or direction of travel of vehicle 24, its propulsion or speed, the actuation or operation of a work tool, such as a bucket, drill, fork or the like carried by the vehicle 24, or the actuation or operation, powering of an implement or attachment pushed, pulled or otherwise operated by the vehicle 24.

As indicated by arrow 69, in some implementations, the predicted location of bounding box 60-3 in bounding box 40-3 may additionally and/or alternatively be used by processor 32 to output control signals to adjust my camera 28 on vehicle 24. For example, in some implementations, the focus or other parameters of camera 28 may be adjusted. In some implementations, camera 28 may be movable or repositioned by an actuator (solenoid, hydraulic/pneumatic cylinder, etc.) supported by vehicle 24, wherein the actuator may adjust the focused direction of camera 28 in response to those control signals from processor 32 that are based upon the detected position of bounding box 60-3 (defining a region in the image and its location that is expected to contain an object or obstacle).

In some implementations, processor 32, CRM 36 and object detection model 50 may be located or stored at various locations. For example, in some implementations, processor 32, CRM 36 and model 50 may be located on or stored on vehicle 24. In some implementations, processor 32 may be located on vehicle 24, whereas CRM 36 and model 50 are remotely located, such as on a remote server access in a wireless fashion by processor 32. In some implementations, processor 32, CRM 36 and model 50 may each be located remote from vehicle 24, but which communicate with a local controller carried by vehicle 24. In such implementations, the object detection model 50 may be utilized by multiple vehicles which are part of a fleet of vehicles. In some implementations, the object detection model 50 may utilized by multiple vehicles, wherein the model 50 is periodically or continuously updated based upon the estimated and predicted locations of bounding boxes and image frames captured by cameras carried by multiple vehicles.

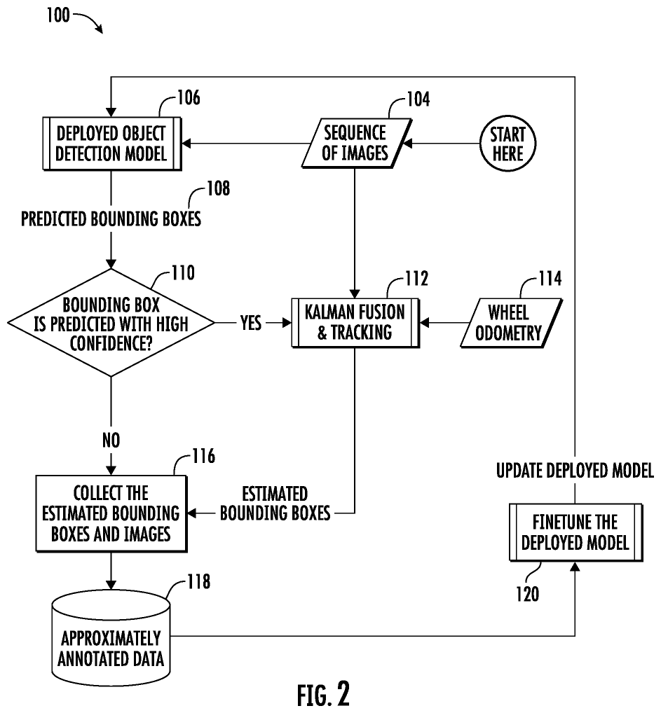

FIG. 2 is a flow diagram outlining an example method 100 for identifying an object or obstacle relative to a stationary or moving vehicle. Method 100 may be carried out by processor 32 following instructions in CRM 36. The method 100 utilizes tracking for object detection.

### Using Tracking for Object Detection

The task of detecting an object in an image is framed as a regression problem to detect the location of the bounding box or rectangle in the image, and as a classification problem to predict the class of the object in the predicted bounding box. FIG. 2. shows the flow diagram example method 100 of automatic data collection of images as well as their annotations in the form of bounding box locations and their class category. As indicated by block 104, a tractor camera stream is fed to an object detection model 106 to detect bounding boxes 108 for the target classes. However, due to time and scene-varying image quality, object movement, ego-motion of the tractor, other environmental factors, etc. the neural network may sometimes miss detections between frames. As indicated by decision block 110, processor 32, following instructions contained in CRM 36, determines whether each particular bounding box 108 has been predicted with a high degree of confidence. In the case where frames are predicted in an image, where the confidence level for the predicted location of the bounding box exceeds a predetermined threshold, the bounding box is fed to a Kalman Filter as indicated by block 112 for tracking the bounding boxes to estimate the location of future bounding boxes. As indicated by block 114, the Kalman filter also contains sensor measurements from the wheel odometry and the velocity of the moving tractor which helps in better tracking the object of interest in the sequence of images. As indicated by block 116, when a deep learning model fails to predict future bounding boxes, the tracking estimated bounding boxes (from block 112) are used as automatically labelled data to further finetune the object detection model (as indicated by blocks 118 and 120).

The process to collect these images and labels is discussed next. The labels of the missing objects are taken to be the same label as the previously predicted bounding boxes in a video sequence. Since these bounding boxes need not be correct, and that there is noise in the labels, label smoothing is used to ensure the models don't take the labels as absolute ground truth but give weights with respect to the confidence that the bounding boxes are correct.

Additionally, to alleviate the effects of noisy bounding boxes, high confidence bounding boxes are taken from previous frames and correlated within a margin around the estimated bounding boxes from the Kalman Filter. Several image-based correlation metrics like mutual information, cross-correlation or normalized cross-correlation can be used to optimally find the location of the bounding box within the image. This step ensures that the tracking capabilities of the Kalman Filter and also the pixel information content in the images are integrated. Only bounding boxes with high confidence in the preceding frames are considered for better tracking. This also gives confidence that the tracking of the bounding box works well in the frames where the model was missing its predictions. These sampled data are called as the approximately annotated data as shown in FIG. 2. Finetuning the deployed neural network produces a better one which is measured in terms of the accuracy of predictions on a hold-out test dataset.

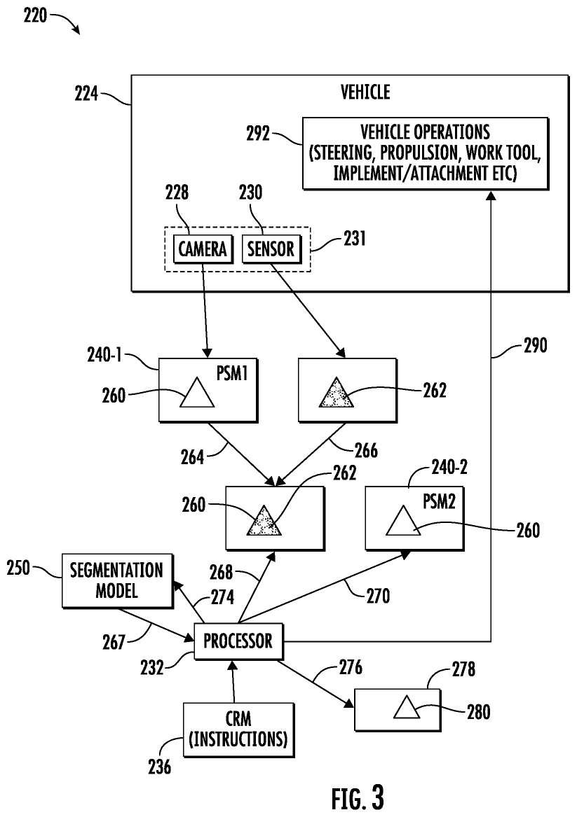

FIG. 3 is a diagram schematically illustrating an example image segmentation system 220. Image segmentation system 220 is configured to segment one or more obstacles or objects and images captured by a camera near a vehicle, such as an automobile or tractor, when the vehicle is stationary or during movement of the vehicle. Vehicles operations, steering of the vehicle, propulsion of the vehicle, actuation of a work tool (such as a bucket, fork, drill) or actuation of an implement or attachment (being pushed or pulled by the vehicle may be adjusted based upon the segmented object or obstacle (its shape, edge coordinates, and/or classification based upon its shape and/or edge coordinates). Detection system 220 facilitates automatic fine-tuning or updating of a machine learning model (in the form of segmentation model or mask) as a stream of images are being captured by a camera carried by the vehicle. System 220 comprises vehicle 224, camera 228, sensor 230, processor 232, and computer readable medium 236.

Vehicle 224 comprises a vehicle configured to traverse a terrain. In some implementations, vehicle 224 is a human driven vehicle having a human operator carried by the vehicle. In some implementations, vehicle 224 is a remotely driven vehicle having a human operator remotely controlling the vehicle from a location remote from the vehicle. In some implementations, vehicle 224 comprises an autonomous vehicle controlled and driven in an automatic fashion by a computerized controller. In some implementations, vehicle 224 may comprise an automobile or truck. In some implementations, vehicle 224 may comprise a tractor, a piece of construction equipment or the like.

Camera 228 comprise a device carried by vehicle 224. Camera 228 is configured to capture and output a stream of image frames including a first image frame 240-1 and a second image frame 240-2 (collectively referred to as image frames 240). Image frames 240 are transmitted to and received by processor 232.

Sensor 230 comprises sensor configured to output a point cloud corresponding to the image of image frame 240-1. As indicated by broken lines, in some implementations, sensor 230 may comprise a second camera which is part of a stereo camera 231 that utilizes images from cameras 228 and 230 to generate the point cloud. In other implementations, sensor 230 may comprise other sensors that output a point cloud, such as a LIDAR sensor.

Processor 232 comprises a processing unit configured to carry out various computing operations based upon instructions contained on computer readable medium 236. Computer readable medium 36 comprises a non-transitory computer-readable medium in the form of software. In some implementations, processor 232 and computer readable medium 236 may be embodied as an application-specific integrated circuit. The instructions contained in computer readable medium 236 direct processor 232 to carry out a process for segmenting potential obstacles or objects in images captured in or near the path of vehicle 224. The instructions contained in computer readable medium 236 direct processor 232 to apply a segmentation model 250 to the received image frames 240.

As schematically indicated by arrow 267, processor 232, following instructions contained in CRM 236, applies the segmentation model 250 to the pixels in image frame 240-1 to produce or output a first prediction segmentation map PSM1 240-1 including pixel labels. The pixel labels may identify each individual pixel as being part of an object 260 or environment/surroundings to the object 260. The pixel labels may identify the boundary, shape or edge of the object 260.

As further shown by FIG. 3, the output from sensor 230 (or stereoscopic camera 231) is a point cloud 262 corresponding to image frame or the predicted segmentation map 240-1. Although the segmented image frame, the predicted segmentation map 240-1, is illustrated as including a single object, in some implementations, the image frame and the predicted segmentation map 240-1 may include multiple objects such that the point cloud 262 includes point clouds of multiple objects.

As schematically indicated by arrows 264, 266 and 268, processor 232, following instructions in CRM 236, fuses predicted segmentation map PSM1 from image 240-1 and the point cloud 262 to label pixels 263 in the point cloud 262. As schematically represented by arrow 270, based upon the labeled pixels 263 in the point cloud, processor 232 relabels the pixels of the predicted segmentation map 240-1 to produce a second predicted segmentation map PSM2 240-2.

For each of the first predicted segmentation map 240-1 and the second predicted segmentation map 240-2, processor 232 computes a quantity objectness score or measurement for the individual object 260. A quantity called objectness score is defined for each object in the segmentation map which represents quantitatively how well the object is defined in each of the two modalities, image and point cloud. This is calculated by the smoothness of the object shape obtained as a predefined function of the inverse of the integration of the gradient of the object shape boundaries. A higher objectness score represents that there are less edges in the objects which is likely to exist in the real world and vice versa. The objectness score of an object in the segmentation map and the depth refined segmentation map is computed. An improvement in the objectness score from the predicted segmentation map to the depth refined segmentation map suggests that the object after refinement is much smoother than the original one. The score is normalized with the number of points in the point cloud that had to change their labels to a particular object based on the segmentation maps in the image. Intuitively this works because when pixels in the segmentation map belonging to a smooth object have variation, the misclassified pixels are remapped to the right label for further finetuning to belong to the smooth object.

The structure of points around an object is utilized to cluster the labelled points and a refined label is assigned. A depth refined segmentation map is a refined predicted boundary or outline of the segmented object in the image. The refinement allows for the relabeling of the segmentation maps.

As schematically indicated by arrow 274, processor 232 updates or adjusts the segmentation model 250 based upon the objectness score and the depth refined segmentation map. When the objectness score is greater in the depth refined map, then it is used as a ground truth of the segmentation. This is used to perform back propagation to fine tune the neural network. Additionally, the loss function at the output of the neural network is modified to make the model predict a segmentation map whose score is as close as possible to the depth refined map. This map is used as the new ground truth to retrain or finetune the neural network to produce a segmentation map upon inference on an image that has a score as close as possible to the objectness score in the depth refined segmentation map.

As schematically indicated by arrow 276, processor 232 applies the updated segmentation model 250 to segment a subsequently captured image frame 278 having pixel labels which identify the shape and perimeter of an obstacle or object 280 corresponding to the prior object 260. The individual pixel labeling (the segmentation) may then be utilized by processor 232 to classify the object, where its location may be determined from its corresponding point cloud.

As indicated by arrow 290, processor 232, following instructions contained in CRM 236, may output control signals, controlling vehicle operation 292 of vehicle 224 based upon the segmented object 280 and/or its classification. Such vehicle operation 292 may include an adjustment to the steering or direction of travel of vehicle 224, is propulsion or speed, the actuation or operation of a work tool, such as a bucket, drill, fork or the like carried by the vehicle 224, or the actuation or operation, powering of an implement or attachment pushed, pulled or otherwise operated by the vehicle 224.

In some implementations, processor 232, CRM 236 and segmentation model 250 may be located or stored at various locations. For example, in some implementations, processor 232, CRM 236 and model 250 may be located on or stored on vehicle 224. In some implementations, processor 232 may be located on vehicle 224, whereas CRM 236 and model 250 are remotely located, such as on a remote server access in a wireless fashion by processor 232. In some implementations, processor 232, CRM 236 and model 250 may each be located remote from vehicle 224, but which communicate with a local controller carried by vehicle 224. In such implementations, the segmentation model 250 may be utilized by multiple vehicles which are part of a fleet of vehicles. In some implementations, the object detection model 250 may be utilized by multiple vehicles, wherein the model 250 is periodically or continuously updated based upon the predicted segmentation maps generated from images captured by multiple vehicles.

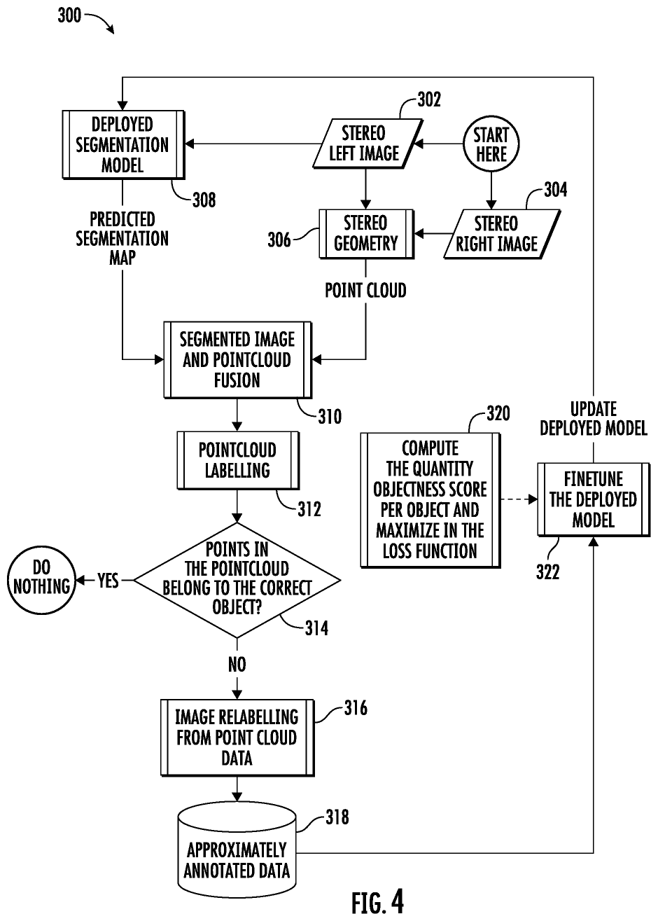

FIG. 4 is a flow diagram outlining an example method 300 for continuously or periodically automatically updating segmentation models.

### Using Depth for Segmentation

Segmentation involves pixel-wise labelling of every pixel of an input image. Collection of such highly detailed annotated images is very costly. Therefore, minimal annotated data is used to train an initial fully convolutional neural network. This model is fine-tuned to improve performance based on information collected about the finesse of the segmentation in comparison to the data collected from a different sensor like a stereo camera (outputting a point cloud).

The clustering algorithm looks at features captured from the color, location and label of the points in the point cloud after fusion with the segmentation map. The similarity of features is used to create clusters and separate from other clusters which are different. The clusters are also constrained to be smooth to ensure object smoothness. Algorithms like K-Means clustering, DBSCAN, and K-Nearest Neighbors have been tested to work well empirically.

Additionally, the cross-entropy loss is regularized with the objectness score to encourage smoother object boundaries. The regularization factor controls the amount of smoothness in the predicted segmentation masks. Whenever there is ground truth of segmentation available, the difference between the objectness scores is also minimized which enables the models to segment objects similar to the structure in the ground truth.

The mathematical formulation of the objectness score, and the usage of the above existing pieces to stitch together an algorithm for the automatic refinement of segmentation maps may improve the neural network and segmentation quality. The algorithm is generic, and methods can be designed to individually improve each of the pieces to improve the overall segmentation quality. In the case of very sharp and well-defined pixel-wise labelling of objects, the regularization factor can be set to a very small value and vice versa.

FIG. 4. shows a detailed description of an example method 300 and may be carried out by processor 32 following instructions contained in CRM 36 to automatically collect data for refining segmentation masks using the stereo-images. Stereo images 302, 304 are used to generate a point cloud (stereo geometry 306 consisting of the pixel location and the corresponding depth. Segmentation of an entire scene is performed with a segmentation model 308 on the tractor/vehicle captured images of one camera (stereo left image 302 in the example) in the stereo camera pair 302, 304. As indicated by block 310, processor 32 performs a fusion of the point cloud with segmentation maps using the camera parameters and triangulation method. As indicated by block 312, this step produces the point cloud with each point here labelled with the object class.

As indicated by decision block 314, a determination is made whether the labeled points in the point cloud belong to the correct object. There may be a few points here that are still unlabeled because of the point correspondence problem with stereo vision. As indicated by block 316, these unlabeled points may become labelled based on the point cloud relabeling algorithm discussed below.

The structure of points around an object is utilized to cluster the labelled points and a refined label is assigned. The refinement allows for the relabeling of the segmentation maps, producing the approximately annotated data 318.

As indicated by block 320, a quantity called objectness score is defined for each object in the segmentation map which represents quantitatively how well the object is defined in each of the two modalities, image and point cloud. This is calculated by the smoothness of the object shape obtained as a predefined function of the inverse of the integration of the gradient of the object shape boundaries. A higher objectness score represents that there are fewer edges in the objects which is likely in the real world and vice versa. The objectness score of an object in the segmentation map and the depth refined segmentation map are computed. An improvement in the objectness score from the predicted segmentation map to the depth refined segmentation map suggests that the object after refinement is much smoother than the original one. The score with the number of points in the point cloud that had to change their labels to a particular object based on the segmentation maps in the image is normalized. Intuitively this works because when pixels in the segmentation map belonging to a smooth object have variation, the misclassified pixels are remapped to the right label for further finetuning to belong to the smooth object.

The clustering algorithm looks at features captured from the color, location and label of the points in the point cloud after fusion with the segmentation map. The similarity of features is used to create clusters and separate from other clusters which are different. The clusters are also constrained to be smooth to ensure object smoothness. Algorithms like K-Means clustering, DBSCAN, and K-Nearest Neighbors have been tested to work well empirically.

Additionally, the cross-entropy loss is regularized with the objectness score to encourage smoother object boundaries. The regularization factor controls the amount of smoothness in the predicted segmentation masks. Whenever there is ground truth of segmentation available, the difference between the objectness scores are further minimized which enables the models to segment objects similar to the structure in the ground truth.

The mathematical formulation of the objectness score, and the usage of the above existing pieces to stitch together an algorithm for the automatic refinement of segmentation maps/model 308 (as indicated by block 322) may improve the neural network and segmentation quality. The algorithm may be generic, and methods may be designed to individually improve each of the pieces to improve the overall segmentation quality. In the case of very sharp and well-defined pixel-wise labelling of objects, the regularization factor can be set to a very small value and vice versa.

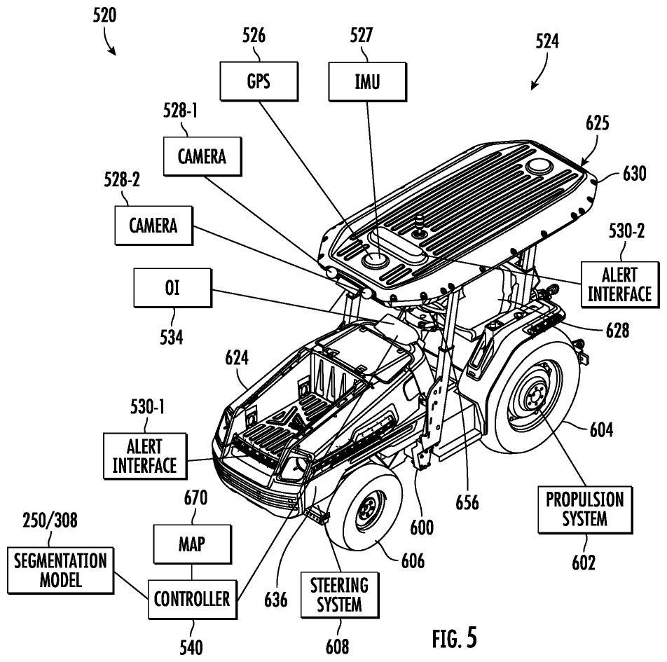

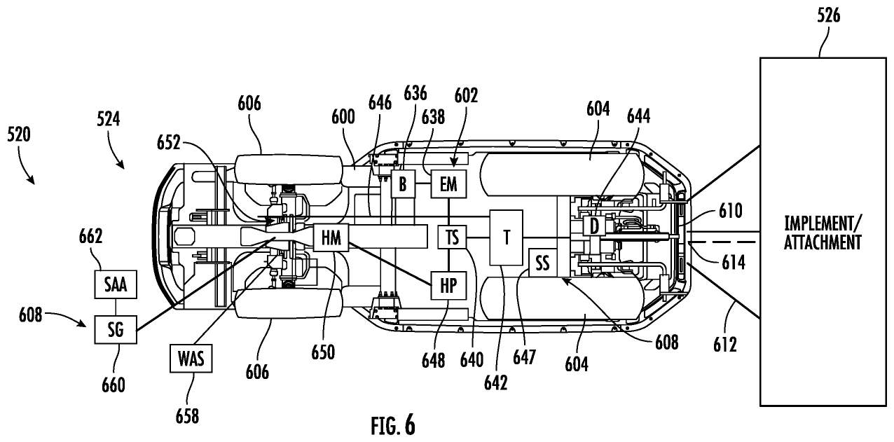

FIGS. 5 and 6 illustrate an example object detection system 520. System 520 comprises a vehicle in the form of a tractor 524. Tractor 524 is configured to push, pull or carry an attached implement 526 (schematically illustrated in FIG. 6). Tractor 524 comprises frame 600, propulsion system 602, rear wheels 604, steered front wheels 606, steering system 608, power takeoff 610, three-point hitch 612, hydraulic output couplings 614, GPS 526, inertial measurement unit 527, cameras 528-1, 528-2 (collectively referred to as cameras 528), alert interfaces 530-1, 530-2 (collectively referred to as alert interfaces 530) and operator interfaces 534.

Frame 600 comprises a structure which supports the remaining components of tractor 524. Frame 600 supports a hood portion 624 and an operator cab 625. Hood portion 624 covers and encloses part of propulsion system 602, such as an internal combustion engine and/or batteries and motors for powering our propelling tractor 524. Hood portion 624 may support alert interfaces 530-1 at a front of the hood. Operator cab 625 comprise that portion of tractor 524 in which an operator of tractor 524 resides during use of tractor 524. In the example illustrated, operator cab 625 comprises seat 628 and roof 630. Seat 628 is beneath roof 630. Roof 630 supports global positioning satellite (GPS) receiver 526 and inertial measurement units 527. Roof 630 further supports cameras 528 and alert interface 530-2.

Propulsion system 602 serves to propel tractor 524 in forward and reverse directions without turning or during turning. As shown by FIG. 6, propulsion system 602 comprises battery 636, electric motor 638, torque splitter 640, transmission 642, rear differential 644, transaxle 646, speed sensor 647 hydraulic pump 648, hydraulic motor 650 and front wheel transmission 652. Battery 636 comprise one or battery modules which store electrical energy. Battery 636 supported within an internal battery receiving cavity provided by frame 600. Battery 636 powers the electric motor 638.

Electrical motor 638 (schematically illustrated in FIG. 6) outputs torque which is transmitted by a gearing to torque splitter 640. Torque splitter 640 transmits torque to transmission 642 and to hydraulic pump 648. Transmission 642 provides a plurality of forward and reverse gears providing different rotational speeds and torques to the rear wheels 604. Transmission 642 further supplies torque to power takeoff 610. Differential 644 comprise a set of driveshafts that cause the rotational speed of one shaft to be the average of the speeds of the other shafts or a fixed multiple of that average.

Transaxle 646 extends from transmission 642 and transmits torque to front wheel transmission 652 for rotatably driving wheels 606. Speed sensors 647 output signals indicating the forward or reverse speed of wheel 604 and of tractor 524. Hydraulic pump 648 supplies pressurized fluid to three-point hitch 612 and hydraulic output couplings 614. Hydraulic pump 648 further supplies pressurized fluid to drive hydraulic motor 650. Hydraulic motor 650 supplies torque to front wheel transmission 652. This additional torque facilitates the rotatable driving of front wheels 606 at speeds that proportionally differ than the rotation speeds at which rear wheels 604 are being driven by transmission 642.

Steering system 608 controls steering of front wheels 606 to control the course of tractor 524. In some implementations, steering system 608 may comprise a steer by wire system which comprises steering wheel 656, wheel angle sensors 658, steering gears 660 and steering angle actuator 662. Steering wheel 656 serves as an input device by which an operator may turn and steer front wheels 606. In the example illustrated, steering wheel 656 is provided as part of tractor 524 within operator cab 625. In other implementations, tractor 524 may omit cab 625, seat 628 or steering wheel 656, wherein steering wheel 656 may be provided at a remote location and wherein signals from manipulation of the steering wheel are transmitted to a controller on tractor 524 in a wireless fashion. The angular position of steering wheel 656 may correspond to or may be mapped to an angular position of the steered front wheels 606. In some implementations, tractor 524 is configured to be steered in an automated fashion by controller 540 according to a sensed surroundings received by controller 540 from various cameras or sensors provided on tractor 524 and/or according to a predefined steering routine, route or path based upon signals from GPS 526 and/or inertial measurement units 527.

Wheel angle sensor 658 comprises one or more sensors, such as potentiometers or the like, that sense angular positioning or steering angle of front wheels 606. Steering gears 660 comprise gears or other mechanisms by which front wheels 606 may be rotated. In some implementations, steering gears 60 may comprise a rack and pinion gear arrangement. Steering angle actuator 662 comprise an actuator configured to drive steering gears 660 so as to adjust the angular positioning of front wheels 606. In some implementations, steering angle actuator 662 comprises an electric motor or hydraulic motor (powered by a hydraulic pump).

Power takeoff 610 comprises a splined shaft or other coupling which may receive torque from transmission 642 and which may supply torque to an implement attached to tractor 524. Three-point hitch 612 may comprise jacks 670 (hydraulic cylinder-piston assemblies) which receive pressurized hydraulic fluid from hydraulic pump 648 and which may be selectively extended and retracted by a valving system to selectively raise and lower lift arms 672 which may be connected to an attached implement to raise and lower the attached implement. Hydraulic output couplings 614 receive hydraulic pressure from hydraulic pump 648 (or another hydraulic pump provide on tractor 524) and supply pressurized hydraulic fluid (via connected hydraulic hoses, shown with a dashed line) to hydraulically powered components, such as a hydraulic jack, hydraulic motor or other hydraulic driven component of implement 526. Coupling 614 may be associated with a hydraulic manifold and valving system to facilitate control over the hydraulic pressure supplied to such coupling 614.

Cameras 528 are supported by roof 630 and face forward directions so as to have a field-of-view configured to encompass any objects that may lie in front of or in the path of tractor 524. Cameras 528 may comprise a monocular/2D camera or may comprise a stereo/3D camera. Cameras 528 may be configured to capture still images and/or video. In the example illustrated, tractor 524 comprise additional cameras situated along and about roof 630, facing in forward and sideways directions. In the example illustrated, at least one of cameras 528 may comprise a stereo camera configured to output signals for generation of a 3D point cloud of the field-of-view of the camera. In some implementations, tractor 524 may provide with a different form sensor configured to output signals for the generation of a 3D point cloud, such as a LIDAR sensor.

Operator interfaces 534 are similar to operator interface 34 described above. Operator interfaces 504 facilitate the provision of information to an operator and the input of commands/information from an operator. In the example illustrated, operator interfaces 534 are in the form of a touchscreen monitor, a console having pushbuttons, slider bars, levers and the like, and a manually manipulable joystick.

Controller 540 comprises processor 32 and CRM 36, described above. The instructions contained in CRM 36 are configured to direct processor 32 to carry out method 100 and/or method 400 described above. Controller 540 may be configured to (1) apply an object detection model to the first image frame to predict a location of a first bounding box of an object in the first image frame, (2) apply a confidence value to the predicted location of first bounding box, (3)in response to the confidence level exceeding a predetermined threshold, estimate a location of a second bounding box in the second image frame based on the location of the first bounding box and non-zero movement of the vehicle, (4) update the object detection model based on the estimated location of the second bounding box in the second image frame, (5) predict a location of a third bounding box in the third image frame using the updated object detection model, and (6) control an operation of the vehicle based on the predicted location of the third bounding box.

Controller 540 may be further configured to (1) apply a segmentation model to the image to output a first predicted segmentation map including pixel labels, (2) fuse the first predicted segmentation map and the point cloud, (3) label pixels in the point cloud, (4) relabel the pixel labels of the predicted segmentation map based on the labeled pixels in the point cloud to produce a second predicted segmentation map, (5) compute a first quantity objectness score for an object in the first predicted segmentation map, (6) compute a second quantity objectness score for an object in the depth refined segmentation map, (7) use the depth refined segmentation map to adjust the segmentation model, (8) adjust the segmentation model with additional constraints in the loss function to output a prediction that mimics the depth refined segmentation map, (9) segment a second image using the updated segmentation map, and (10) control an operation of the vehicle based on the segmenting of the second image. Controller 540 may be configured to continuously or periodically update and fine tune a segmentation model 250/308 as described above. Controller 540 may further utilize the adjusted or fine-tuned segmentation model 250/308 to adjust our control vehicle operations.

In some implementations, based upon the updated or fine-tuned segmentation model 257/308 and/or based on the predicted location of the third bounding box (as described above), controller 540 may output control signals to propulsion system 6022 adjust the speed of tractor 524. Controller 540 may output control signals to alter a setting of the transmission 642, alter the electrical charge being provided by battery 636, and/or alter the output of electric motor 638. For example, controller 540 may identify an obstacle in the upcoming path of tractor 524 using the updated segmentation model 250/308. Based upon this obstacle identification, controller 540 may adjust the speed of tractor 524 to delay the encounter or to provide sufficient time for avoidance of the obstacle.

In some implementations, based upon the updated or fine-tuned segmentation model 257/308 and/or based on the predicted location of the third bounding box (as described above), controller 540 may identify an approaching obstacle or an obstacle within the path of tractor 524, wherein controller 540 outputs control signals to steering system 608 to avoid the obstacle. Controller 540 may output control signals to the steering angle actuator 6622 adjust or alter the current path of tractor 524, steering around or in a direction so as to avoid the identified obstacle.

In some implementations, based upon the updated or fine-tuned segmentation model 257/308 and/or based on the predicted location of the third bounding box (as described above), controller 540 may identify an approaching obstacle or an obstacle within the path of tractor 524, wherein controller 540 outputs control signals causing at least one of alert interfaces 530 to output a notification or warning to the obstacle. For example, controller 540 may output control signals causing an audible or visual alert to be divided. In some implementations, controller 540 may cause lights of at least one of alert interfaces 532 flash or increase intensity. In some implementations, controller 540 may output control signals causing an intensity of the hood lights to be increased to facilitate enhanced viewing of the obstacle by an operator.

In some implementations, based upon the updated or fine-tuned segmentation model 257/308 and/or based on the predicted location of the third bounding box (as described above), controller 540 may identify an approaching obstacle or an obstacle within the path of tractor 524, wherein controller 540 outputs control signals causing the rpm of PTO 610 to be adjusted and/are causing implement/attachment 526 to be raised or lowered social avoid the identified obstacle. For example, controller 540 may output control signals causing the three-point hitch 612 to raise implement/attachment 526 to a height such that the tractor 524 and the implement/attachment 526 may pass over the identified obstacle. Controller 540 may output control signals causing hydraulic pressure to be supplied to a hydraulic jack of implement/attachment 526 to raise the implement/attachment 526 such that the implement/attachment 526 may be passed over the identified obstacle. In some implementations, based upon the updated or fine-tuned segmentation model 257/308, controller 540 may identify an approaching obstacle or an obstacle within the path of tractor 524, wherein controller 540 determines the geographic coordinates of tractor 524 based upon signals from GPS 526 and/or IMU 527, wherein controller 540 determines the geographic coordinates of the identified obstacle and wherein controller 540 stores the geographic coordinates of the identified obstacle. For example, controller 540 may store the geographic coordinates of the identified obstacle as part of a map 670.

Each of the above describe example vehicle operations may be adjusted by controller 540 in an automated fashion, without operator input or authorization. Such automation may facilitate faster response to an identified obstacle. In other implementations, all or certain of the above noted vehicle operation adjustments may first require authorization from an operator. For example, controller 540 may output a notification to the operator recommending a particular vehicle operation adjustment, via operator interface 534, wherein the adjustment is carried out by controller 540 upon receiving an authorization input from the operator, via operator interface 534, for the recommended adjustment.

As discussed above, controller 540 may reside on tractor 524, may be remote from tractor 524 or may portions that are both on tractor 524 and remote from tractor 524. Likewise, segmentation model 250/308 may be stored on tractor 524, may be stored remote from tractor 524 or may have portions stored on tractor 524 and portion stored remote from tractor 524. In implementations where controller 540 is remote from tractor 524, controller 540 may communicate with a local controller on tractor 524 in a wireless fashion. Likewise, in implementations where segmentation model 250/308 is remote from tractor 524, controller 540 or another controller on tractor 524 may communicate with a remote server that provides access to library 550 and/or associations 560.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An object detection system comprising:
a vehicle;
a camera carried by the vehicle to output a stream of image frames including a first image frame, a second image frame, and a third image frame;
a processor; and
a non-transitory computer-readable medium containing instructions to direct the processor to:
apply an object detection model to the first image frame to predict a location of a first bounding box of an object in the first image frame;
apply a confidence value to the predicted location of first bounding box;
in response to the confidence level exceeding a predetermined threshold, estimate a location of a second bounding box in the second image frame based on the location of the first bounding box and non-zero movement of the vehicle;
update the object detection model based on the estimated location of the second bounding box in the second image frame;
predict a location of a third bounding box in the third image frame using the updated object detection model; and
control an operation of the vehicle based on the predicted location of the third bounding box.

2. The system of claim 1, wherein the estimating of the location of the second bounding box in the second image comprises applying a Kalman filter and correlating the estimated location of the second bounding box within a margin around the location of the first bounding box.

3. The system of claim 1, wherein the updating of the object detection model is based on a plurality of estimated locations of bounding boxes in a plurality of respective image frames.

4. The system of claim 1, wherein the vehicle comprises a propulsion system and wherein the instructions are configured to direct the processor to output control signals to the propulsion system to adjust a speed of the vehicle based on the predicted location of the third bounding box.

5. The system of claim 1, wherein the vehicle comprises a steering system and wherein the instructions are configured to direct the processor to output control signals to the steering system to adjust steering of the vehicle based on the predicted location of the third bounding box.

6. The system of claim 1, wherein the vehicle is coupled to an attachment/implement and wherein the instructions are configured to direct the processor to output control signals causing the implement/attachment to be raised based on the predicted location of the third bounding box.

7. The system of claim 1, wherein the vehicle comprises an alert interface and wherein the instructions are configured to direct the processor to output control signals to the alert interface causing actuation of the alert interface based on the predicted location of the third bounding box.

8. The system of claim 1, wherein the vehicle comprises at least one of a global positioning satellite (GPS) system and wherein the instructions are configured to direct the processor to (1) determine and store geographic coordinates of an obstacle based upon signals from GPS system and the predicted location of the third bounding box.

9. A non-transitory computer-readable medium containing instructions to direct the processor to:
apply an object detection model to a first image frame to predict a location of a first bounding box of an object in the first image frame;
apply a confidence value to the predicted location of first bounding box;
in response to the confidence level exceeding a predetermined threshold, estimate a location of a second bounding box of the object in a second image frame based on the location of the first bounding box and non-zero movement of the vehicle; and
update the object detection model based on the estimated location of the second bounding box in the second image frame;
predict a location of a third bounding box of the object in a third image frame using the updated object detection model; and
control an operation of the vehicle based on the predicted location of the third bounding box.

10. The medium of claim 9, wherein the updating of the object detection model is based on a plurality of estimated locations of bounding boxes in a plurality of respective image frames.

11. The medium of claim 9, wherein the medium is for use with a vehicle comprising a propulsion system and wherein the instructions are configured to direct the processor to output control signals to the propulsion system to adjust a speed of the vehicle based on the predicted location of the third bounding box.

12. The medium of claim 9, wherein the medium is for use with a vehicle comprising a steering system and wherein the instructions are configured to direct the processor to output control signals to the steering system to adjust steering of the vehicle based on the predicted location of the third bounding box.

13. An image segmentation system comprising:
a vehicle;
a camera carried by the vehicle to output an image;
a sensor to output a point cloud corresponding to the image;
a processor; and
a non-transitory computer-readable medium containing instructions to direct the processor to:
apply a segmentation model to the image to output a first predicted segmentation map including pixel labels;
fuse the first predicted segmentation map and the point cloud;
label pixels in the point cloud;
relabel the pixel labels of the predicted segmentation map based on the labeled pixels in the point cloud to produce a second predicted segmentation map;
compute a first quantity objectness score for an object in the first predicted segmentation map;
compute a second quantity objectness score for an object in the depth refined segmentation map;
use the depth refined segmentation map to adjust the segmentation model;
adjust the segmentation model with additional constraints in the loss function to output a prediction that mimics the depth refined segmentation map;
segment a second image using the updated segmentation map; and
control an operation of the vehicle based on the segmenting of the second image.

14. The system of claim 13, wherein the sensor comprises a second camera, the camera and the second camera forming a stereo camera.

15. The system of claim 13, wherein the sensor comprises a LIDAR sensor.

16. The system of claim 13, wherein the vehicle comprises a propulsion system and wherein the instructions are configured to direct the processor to output control signals to the propulsion system to adjust a speed of the vehicle based on the segmenting of the second image.

17. The system of claim 13, wherein the vehicle comprises a steering system and wherein the instructions are configured to direct the processor to output control signals to the steering system to adjust steering of the vehicle based on the segmenting of the second image.

18. The system of claim 13, wherein the vehicle is coupled to an attachment/implement and wherein the instructions are configured to direct the processor to output control signals causing the implement/attachment to be raised based on the segmenting of the second image.

19. The system of claim 13, wherein the vehicle comprises an alert interface and wherein the instructions are configured to direct the processor to output control signals to the alert interface causing actuation of the alert interface based on the segmenting of the second image.

20. The system of claim 13, wherein the vehicle comprises at least one of a global positioning satellite (GPS) system and wherein the instructions are configured to direct the processor to (1) determine and store geographic coordinates of an obstacle based on the segmenting of the second image.
